(19) United States
(12) Patent Application Publication
(10) Pub. No.: US 2008/0220323 A1
(43) Pub. Date: Sep. 11, 2008

(54) CAST ENCLOSURES FOR BATTERY REPLACEMENT UNITS

(75) Inventors: Adrian J. Corless, Vancouver (CA); David Aaron Leboe, Vancouver (CA); Neil Brian Fagan, Vancouver (CA); Kenneth William Kratschmar, Vancouver (CA); Hamid Reza Tamehi, North Vancouver (CA); Jeremy Shane Lindstrom, Vancouver (CA); Zebedee James Lander, New Westminster (CA); Christopher E.J. Reid, Vancouver (CA)

Correspondence Address: HOLLAND & HART LLP, 60 E. South Temple, Suite 2000, P.O. Box 11583, Salt Lake City, UT, 84110, US

(73) Assignee: Cellex Power Products, Inc., Richmond (CA)

(21) Appl. No.: 11/852,830

(22) Filed: Sep. 10, 2007

Related U.S. Application Data
(63) Continuation of application No. 10/698,977, filed on Oct. 31, 2003, now abandoned.

(51) Int. Cl. H01M 2/10

(52) U.S. Cl. 429/100

(57) ABSTRACT

This application relates to cast enclosures for battery replacement application, such as enclosures configured to house power units comprising a fuel cell and an energy storage device. The enclosures function as protective enclosures and counterweights, provide mounting points and conduits for gases, fluids, plumbing and wiring, and serve as thermal energy storage/transfer devices. The enclosures are formed in a mold or die and comprise wall portions defining a plurality of internal subcompartments for receiving the various system components. In one embodiment of the invention channels may be formed in the wall portions of the enclosures for circulating a heat transfer fluid therethrough.

### RELATED APPLICATION

This is a continuation of U.S. patent application Ser. No. 10/698,977, filed on 31 Oct. 2003, now pending, the disclosure of which is incorporated, in its entirety, by this reference.

### TECHNICAL FIELD

This application relates to cast enclosures for battery replacement power units, such as power units comprising a fuel cell and an energy storage device.

### BACKGROUND

In electric power systems operating under dynamic loads, hybridization has been proposed as a means to reduce the size of the power unit. As described in Applicant's application Ser. No. 09/785,878, the disclosure of which is incorporated herein by reference, the power unit (e.g., a fuel cell and reformer) can be sized to meet the average power requirements of a load rather than the peak power requirements. The peak power demands are met by an energy storage device separate from the power unit, such as one or more batteries or capacitors. In the case of the duty cycle of an electric lift truck, for example, hybridization results in a significant reduction in the size of the higher price fuel cell components of the system.

Electric lift trucks are ordinarily powered by traction batteries which are relatively heavy and robust. Fuel cell systems, by contrast, are much lighter and are sensitive to environmental conditions such as vibration, shock, airborne contaminants, temperature fluctuations and moisture. It is not a trivial matter to package the internal components of a fuel cell systems in a compact size while also meeting minimum weight and other technical requirements. For example, the electrical and fluid interconnections required between internal components do not permit the components to be very tightly packed, leaving voids of largely unusable space. The larger size void spaces may be filled with ballast to increase the weight of the fuel cell system. However, the internal voids are not specifically configured to receive ballast and the positioning of the counterweights may not be optimum.

Enclosures for battery replacement power units are typically made from sheet metal or plate. This means that all the mounting points are provided by brackets. The internal components are protected only by the thickness of the sheet metal or plate. Vibration damping is provided by mounting vulnerable components on vibration isolators which takes up valuable space.

Further, the thermal subsystem, such as the heat exchanger, fan and pump, are typically sized to reject the maximum amount of heat produced by the fuel cell and other heat-generating components at the highest ambient temperature conditions. Thus the thermal subsystem is often grossly oversized for average operating conditions. As a result, the thermal subsystem also takes up an excessive amount of space and increases the overall size and capital cost of the power unit.

The need has therefore arisen for cast enclosures specifically adapted for battery replacement power units which function as protective enclosures, counterweights, vibration dampeners and thermal energy storage and/or heat transfer devices. The enclosures also provide convenient mounting points and conduits for fluids, gases, plumbing and wiring.

### SUMMARY OF INVENTION

In accordance with the invention, a cast enclosure formed in a mold or die is provided. The enclosure is configured for housing components of a power unit suitable for battery replacement applications. The enclosure comprises wall portions defining a plurality of internal subcompartments for receiving the various components. At least some of the subcompartments may also comprise conduits for containing and/or conveying gases, fluids, plumbing, wiring and the like.

The enclosure may be assembled from a plurality of cast sections. The cast sections may be formed from metal or some other material having a high thermal mass. Some of the subcompartments may be configured to receive a heat-generating component, such as a fuel cell stack. Other subcompartments may be configured to receive a fuel storage device.

The wall portions of the enclosure are of varying thickness such that voids between the components housed within the enclosure are minimized. This in turn increases the overall weight of the enclosure and minimizes the explosive energy of any leaked gas or vapor within the enclosure. Preferably the weight of the enclosure, when housing the various components, approximates the weight of an electric vehicle traction battery.

Vibration dampeners may be located in at least some of the subcompartments for reducing vibration of components housed within the enclosure. The dampeners may comprise, for example, a particle bed. A vibration isolator may also be mounted on a base portion of the enclosure for isolating the enclosure from an underlying support surface, such as a vehicle traction battery tray.

The enclosure may comprise integral mounting points located on an outer surface thereof. The enclosure may also comprise recessed surfaces and removable external cover plates securable to the recessed surfaces.

In one embodiment of the invention channels may be formed in the wall portions for circulating a heat transfer fluid therethrough, wherein thermal energy is transferable from a heat-generating component housed within a subcompartment to the wall portions through the heat transfer fluid. A radiator may also be thermally coupled to the heat transfer fluid. Thermal energy may be stored in the enclosure wall portions and/or dissipated to a surrounding ambient environment by convection or radiation over outer surfaces of the enclosure or by means of the heat transfer fluid as it is circulated through the radiator.

The invention also relates to a power unit for providing electrical power to a dynamic load. The power unit includes at least one heat-generating component adjustable between different operating states depending upon the power requirements of the load; a cast enclosure comprising wall portions defining a plurality of internal subcompartments, wherein the heat-generating component is housed within one of the subcompartments; and a thermal subsystem for rejecting heat from the heat-generating component to the wall portions of the enclosure. The thermal subsystem may, for example, reject heat to the wall portions by conduction or convection. In one embodiment the thermal subsystem may comprise at least one channel formed in the wall portions for flowing a heat transfer fluid therethrough. The thermal subsystem may include a radiator separate from the wall portions through which the heat transfer fluid is circulated.

Preferably the thermal subsystem is located within the enclosure and is sized to reject less than the maximum amount of heat produced by the heat-generating component under high load conditions. In one embodiment the thermal subsystem is sized to reject approximately the average amount of heat generated by the heat-generating device during an operating session of the power generating device characterized by fluctuating loads. A controller may be provided for controlling the amount of the heat transfer fluid circulated through the channel. In one embodiment the power generating device is a hybrid system and the heat-generating device is a fuel cell.

The invention may also include an assembly comprising a plurality of cast enclosures as described above. For example, one of the cast enclosures may enclose a power unit and another one of the cast enclosures may enclose a fuel supply for the power unit

The invention may deploy in an electric lift vehicle having a battery tray sized for ordinarily receiving a traction battery. The cast enclosure is sized so as to be positionable in the battery tray in substitution for the traction battery. A vibration isolator may be positioned between the cast enclosure and the battery tray surface. The power unit, including the cast enclosure, approximates the weight of a traction battery.

A method of regulating the temperature of a power unit having at least one heat-generating component is also described. The method includes the steps of:
(a) providing a cast enclosure for enclosing the power unit, the enclosure comprising wall portions defining a subcompartment for holding the heat-generating component;
(b) rejecting heat from heat-generating component to the wall portions; and
(c) transferring the heat from the wall portions to an environment surrounding the enclosure.
   The heat may be transferred from the wall portions to the environment during periods when the heat-generating component is in an idle or shut-down mode. The step of rejecting the heat may comprise conveying a heat transfer fluid through the wall portions in the vicinity of the subcompartment. In one embodiment the heat-generating component has a fuel cell stack and the heat transfer fluid is passed relative to the fuel cell stack.

The method may further comprise the step of controllably adjusting the amount of heat transfer fluid passed through the wall portions depending upon the operating state of the thermal subsystem. In one embodiment the heat transfer fluid may be circulated through a radiator.

### BRIEF DESCRIPTION OF DRAWINGS

In drawings which illustrate embodiments of the invention, but which should not be construed as restricting the spirit or scope of the invention in any way,

FIG. 1 is a cut-away view showing the components of a fuel cell/battery hybrid power system arranged within a conventional enclosure.

FIG. 2 is an exploded, isometric view of cast enclosures configured in accordance with one embodiment of the invention.

FIG. 3 is a first end elevational view of the cast enclosures of FIG. 2.

FIG. 4 is a second end elevational view of the cast enclosures of FIG. 2.

FIG. 5 is a first side elevational view of the cast enclosures of FIG. 2.

FIG. 6 is a second side elevational view of the cast enclosures of FIG. 2.

FIG. 7 is a top plan view of the cast enclosures of FIG. 2.

FIG. 8 is a cross-sectional view of one embodiment of the invention showing one means of shock and vibration isolation and damping.

FIG. 9 is schematic view showing integration of the cast enclosure with the thermal management subsystem of a power unit.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

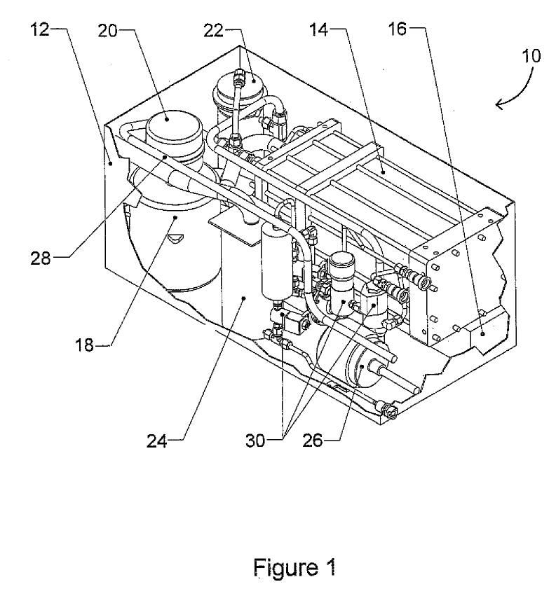

FIG. 1 illustrates a conventional means for packaging components of a fuel cell system 10 within an enclosure 12 of the prior art, System 10 includes a fuel cell 14, power electronics 16, air blower 18, air filter 20, cooling fluid filter 22, water knock out 24, cooling pump 26, and various plumbing conduits 28 and valves 30. FIG. 1 shows that, due to the various interconnections between components 14-30, the components cannot be arranged more densely within enclosure 12. Enclosure 12 is typically fabricated from sheet metal or plate and does not include any internal subcompartments.

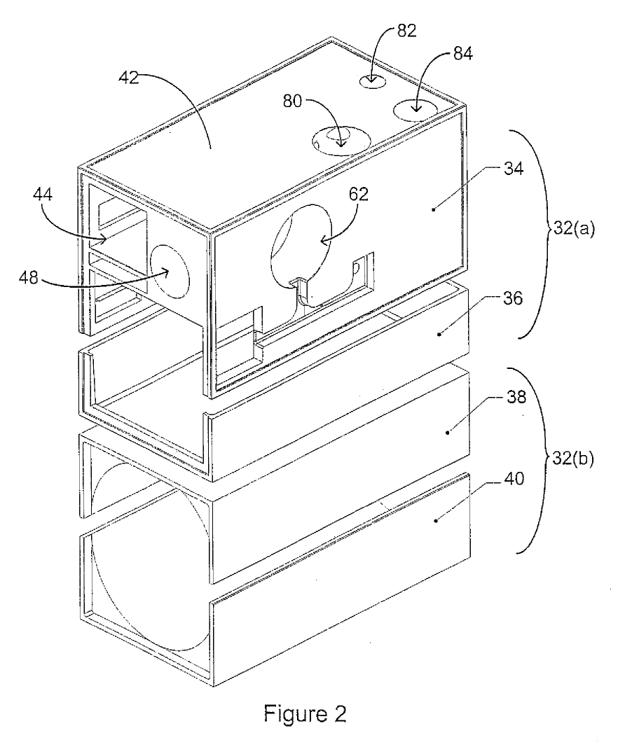

FIG. 2 illustrates cast enclosures constructed in accordance with the invention. In particular, an upper enclosure 32(a) consisting of a power generation and balance of plant casting 34 and a power electronics 36 casting is shown. A lower enclosure 32(b) consisting of an upper fuel storage casting 38 and a lower fuel storage casting 40 is also shown. Enclosures 32(a) and (b) may optionally be stacked one above the other as shown in FIG. 2. Both enclosures 32(a) and (b) have a plurality of internal subcompartments as described below. As used in this patent application the term “cast enclosure” means an enclosure which is formed in a mold or die. A cast enclosure may be formed from metal or any other castable material. As described herein such an enclosure differs from conventional enclosures as exemplified by FIG. 1 which are fabricated from separate sheets or plates.

Castings 34-40 may include recessed surfaces 42 for receiving accessory components such as removable cover plates (not shown). Cover plates are securable to surfaces 42 with screws or other fasteners. Suitable fasteners may also be provided for coupling castings 34 and 36 and castings 38 and 40 together.

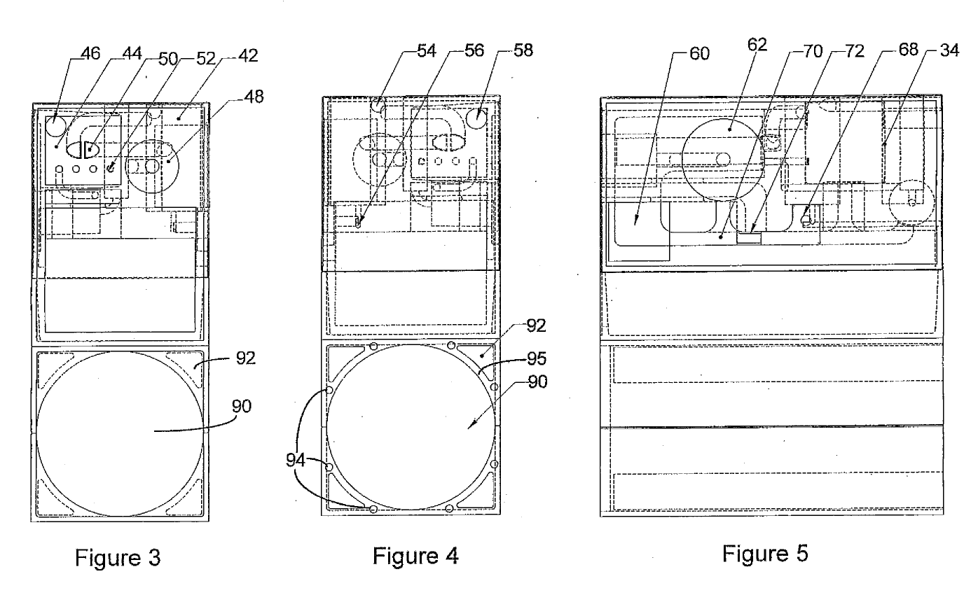

As shown in FIG. 3, power generation and balance of plant casting 34 includes a fuel cell subcompartment 44, a cooling fluid subcompartment 46 (i.e. defining a cooling fluid reservoir), an air filter subcompartment 48, and conduit subcompartments 50 and 52 for plumbing and wiring. Other conduit subcompartments 54, 56 and 58 are best shown in FIG. 4 for conveying oxidant air, product water and fuel cell ventilation air respectively.

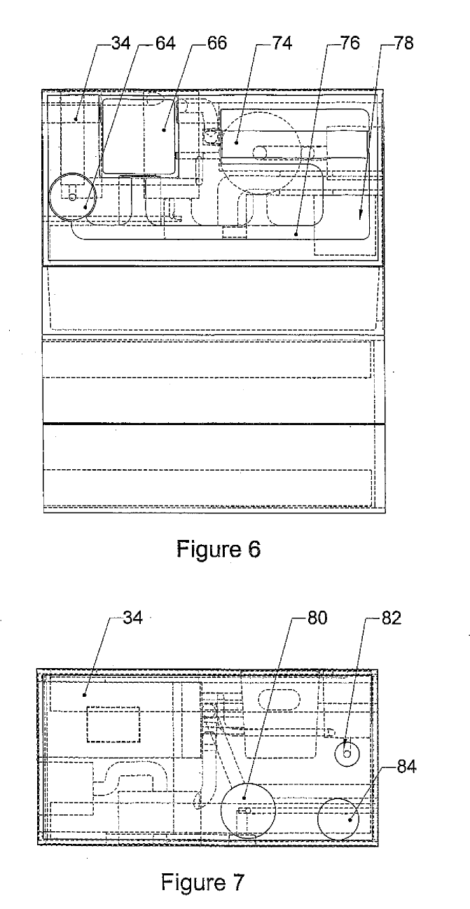

FIGS. 5 and 6 show other internal features of casting 34. As shown in FIG. 5, casting 34 includes a fuse panel subcompartment 60 which also permits pass-through of cables. An air blower subcompartment 62, cooling fluid pump subcompartment 64, valving subcompartment 66 and solenoid valve manifold port subcompartment 66 are also shown. Subcompartments 72, 74, 76 and 78 denote conduits or cavities for passage of cables or the like.

FIG. 7 further shows a water knock out subcompartment 80, a cooling fluid subcompartment 82 and a cooling fluid filter subcompartment 84.

As will be appreciated by a person skilled in the art, the configuration of castings 34 and 36 shown in FIGS. 2-7 is illustrative only and the number and placement of the subcompartments and subcomponent interconnections may vary without departing from the invention.

Enclosure 32(b) has a more simplified configuration in comparison to enclosure 32(a). Castings 38, 40 together define a cylindrical fuel storage subcompartment 90 and a plurality of particle bed dampening subcompartments 92. Subcompartment 90 may be sized, for example, to receive a hydrogen storage cylinder. Channels 94 for conveying heat transfer fluid may also be formed in wall portions 95 for transferring thermal energy to castings 38, 40, as shown in FIG. 4 and described below.

The enclosures 32(a) and 32(b) of FIGS. 2-7 offer numerous advantages in comparison to the prior art enclosure of FIG. 1. Since enclosures 32(a) and (b) are formed from castings, the external and internal wall thicknesses may vary and may be much larger than metal sheets or plates. Enclosures 32(a) and (b) are therefore more massive and provide greater ballast weight in comparison to prior art enclosures 12 fabricated principally from sheet metal or plate. For example, enclosure 32(a) and 32(b), when enclosing the internal components of a power unit, may be sized to approximate the weight of a conventional electric vehicle traction battery.

Cast enclosures 32(a) and (b) minimize or eliminate the need for separate brackets or housings for each of the system components. As shown in FIG. 2, attachment points 43 may be cast-in enclosures 32(a) and (b) to avoid the need for separate mounting brackets. As indicated above, recessed surfaces 42 for receiving removable access cover plates may also be provided. Subcompartments or cavities are defined by wall portions 95 within enclosures 32(a) and (b) for housing various system components such as cartridge valves, sensors, pump impellers, air cooling fins and the like. Some compartments may comprise cast-in liquid channels or reservoirs. Further, some subcompartments may be configured to minimize or eliminate the need for separate air ducts, partitions, pipes hoses and wiring conduits (i.e. wall portions 95 will themselves define integral ducts and the like).

Since enclosures 32(a) and 32(b) comprise a number of separate subcompartments, use of all available internal space is optimized. Instead of having a plurality of small, unusable voids between system components (FIG. 1), the cast enclosures of the invention define internal wall portions 95 (RIG. 2) between components for increased ballast and thermal storage/transfer capability.

Further, since system components are physically separated in individual subcompartments, enclosures 32(a) and 32(b) provide improved protection of potentially fragile components and enhanced shock and vibration isolation. This is due to the higher rigidity, strength and inertia of wall portions 95 as compared to conventional housings fabricated from sheet metal or plate. As shown in FIG. 2, enhanced rigidity results from extra metal filling internal voids, including cast radii in corner portions of enclosures 32(a) and 32(b).

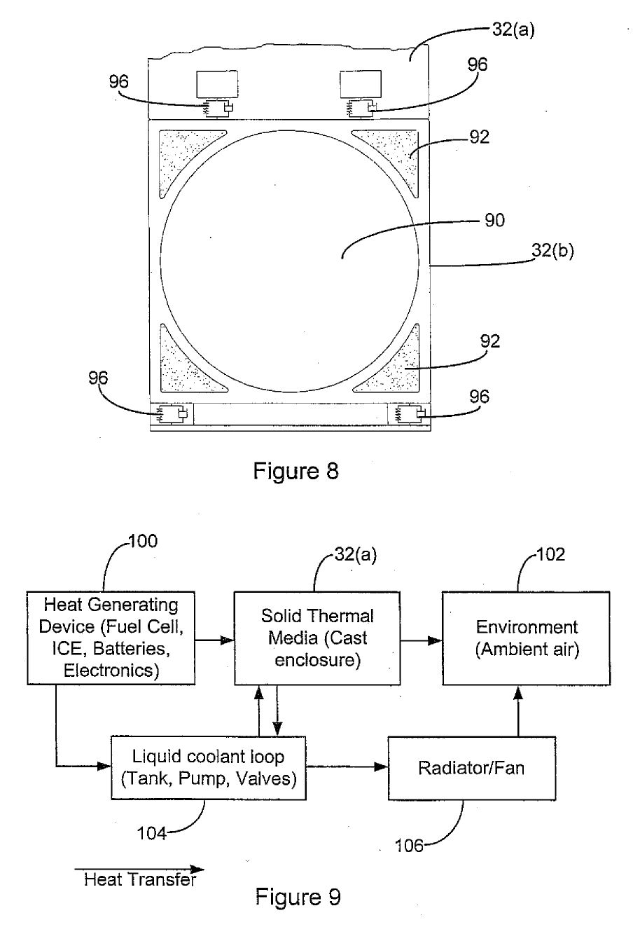

Components which are sensitive to vibration are confined within their own specific subcompartments which are sized and configured to conform to the component in question. Vibration dampening material suitable for a particular component may be positioned directly in the corresponding subcompartment or in other regions of the enclosures. As shown in FIG. 8, enclosure 32(b), for example, may include a plurality of particle bed dampening subcompartments 92 formed in corner regions thereof. Subcompartments 92 could be filled with granular materials such as viscoelastic particles to help dissipate vibration as is well known in the prior art.

FIG. 8 also illustrates vibration isolation pads 96 which could be disposed between an enclosure 32(b) and an underlying support tray or optionally between enclosure 32(b) and vulnerable components housed therein. Isolation pads may comprise, for example, a vibration isolator/pad, a spring and a damper. Thus multiple degrees of vibration isolation are possible in the practice of the invention. Placing the first level of isolation between enclosure 32(b) and the underlying support tray takes advantage of the mass of enclosures 32(a) and (b) for damping purposes. The first level of isolation will filter or significantly reduce a large portion of the input disturbances transmitted to the fuel cell system. The second level of isolation is achieved by placing isolation pads 96 or other vibration dampening material between the casting and the individual system components (e.g. within one or more of the subcompartments). The second stage of isolation is effective at reducing input disturbances at frequencies lower than the natural frequency of the first stage isolations. This combined approach helps dissipate shock and vibration energy in a more controlled and tunable manner than prior art solutions.

Further, by limiting the free space within enclosure 10 with cast material, this also limits the free space available for explosive gases, liquids or other reactants to accumulate if there is a leakage. Accordingly, this limits the amount of explosive energy which could be stored internal to the casting.

The increased thickness and continuity of wall portions 95 also provides an opportunity to employ the enclosure mass as a means of conveying heat from components located within enclosures 32(a) and (b) to the environment and/or as a thermal energy storage device. As shown best in FIG. 4, a thermal transfer fluid may be circulated through channels 94 formed in wall portions 95 of casting 38 (or some other ballast structure within cast enclosures 32(a) and (b)). For example, during periods of peak thermal generation from a fuel cell 14 housed within a fuel cell subcompartment 44, a portion or all of the coolant could be circulated through channels 94. This would enable the transfer of heat from the fuel cell 14 to wall portions 95 or other portions of the enclosure 32. A control system could be provided for regulating the amount of coolant flowing through channels 94 such that the temperature of coolant entering the fuel cell 14 satisfied system requirements. This allows the thermal subsystem to be sized for less than the maximum anticipated thermal duty from the fuel cell 14 which will save cost and volume. During times when no thermal rejection is required by the fuel cell 14, the thermal subsystem could continue to reject the thermal energy stored in wall portions 95 or other ballast mass. The thermal subsystem could thus operate much more independently from the fuel cell subsystem or module and could be rejecting heat when the fuel cell 14 is in idle or shut-down mode. Outer surfaces of enclosures 32(a) and 32(b) may optionally include fins for facilitating thermal transfer to the ambient environment.

As will be apparent to a person skilled in the art, wall portions 95 or other ballast means may function as a heat sink irrespective of the heat-generating component housed within enclosures 32(a) and 32(b). For example, an internal combustion engine could be used as a power unit rather than a fuel cell 14

FIG. 9 is a schematic illustration showing integration of a cast enclosure 32(a) with the thermal management subsystem of a power unit. In this illustrated embodiment the power unit comprises a heat-generating component 100, which could, for example, comprise a fuel cell, internal combustion engine, energy storage device or power electronics component. As described above, cast enclosure 32(a) is formed from a solid material having a high thermal mass, such as cast metal. Enclosure 32(a) provides a means for rejecting heat from heat-generating component 100 to an environment 102 surrounding enclosure 32(a), such as ambient air. As explained above, cast enclosure 32(a) may be configured to store thermal energy from heat-generating component 100 during periods of high load demands and dissipate heat to the surrounding environment, including during periods of low load demands.

As shown in FIG. 9 and described above, in one particular embodiment, heat may be rejected from heat-generating component 100 to cast enclosure 32(a) through a coolant loop 104 which may comprise a coolant conduit, pumps, valves and the like. Optionally the coolant loop 104 may be thermally coupled to a radiator 106 for dissipating heat directly to the surrounding environment. Radiator 106 may be housed within cast enclosure 32(a) or it may comprise a separate component.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A cast enclosure formed in a mold or die for housing components of a power unit suitable for battery replacement applications, wherein said enclosure comprises wall portions defining a plurality of internal subcompartments for receiving said components.

2. The enclosure as defined in claim 1, wherein said subcompartments comprise cavities within said enclosure for receiving said components.

3. The enclosure as defined in claim 1, wherein at least some of said subcompartments comprise conduits for containing materials selected from the group consisting of gases, fluids, plumbing and wiring.

4. The enclosure as defined in claim 1, wherein said enclosure is assembled from a plurality of cast sections.

5. The enclosure as defined in claim 1, wherein said enclosure is formed from cast metal.

6. The enclosure as defined in claim 1, wherein one of said components is a power unit and wherein one of said subcompartments is configured to receive said power unit.

7. The enclosure as defined in claim 6, wherein said power unit comprises a fuel cell stack and wherein one of said compartments is configured to receive said fuel cell stack.

8. The enclosure as defined in claim 1, wherein one of said components is a fuel storage device and wherein one of said subcompartments is configured to receive said fuel storage device.

9. The enclosure as defined in claim 1, wherein the weight of said enclosure when housing said components approximates the weight of an electric vehicle traction battery.

10. The enclosure as defined in claim 1, wherein said wall portions are of varying thickness such that voids between said components within said enclosure are minimized.

11. The enclosure as defined in claim 1, further comprising a vibration dampener located in at least some of said subcompartments.

12. The enclosure as defined in claim 11, wherein said vibration dampener comprises a particle bed.

13. The enclosure as defined in claim 1, wherein said enclosure comprises a base and wherein said enclosure further comprises vibration isolators mounted on said base.

14. The enclosure as defined in claim 1, wherein said enclosure further comprises vibration isolators located between at least some of said components and said wall portions.

15. The enclosure as defined in claim 1, wherein said enclosure comprises integral mounting points.

16. The enclosure as defined in claim 15, wherein said mounting points are located on an outer surface of said enclosure.

17. The enclosure as defined in claim 1, wherein said enclosure is formed from a material having a high thermal mass.

18. The enclosure as defined in claim 17, wherein said enclosure is formed from cast metal.

19. The enclosure as defined in claim 1, wherein said enclosure comprises recessed surfaces and removable external cover plates securable to said recessed surfaces.

20. The enclosure as defined in claim 17, further comprising channels formed in said wall portions for circulating a heat transfer fluid therethrough, wherein thermal energy is transferable from said subcompartments housing heat-generating components to said wall portions through said heat transfer fluid.

21. The enclosure as defined in claim 20, further comprising a radiator thermally coupled to said heat transfer fluid.

22. The enclosure as defined in claim 17, wherein said enclosure houses at least one heat generating component within one of said subcompartments, wherein thermal energy is transferable from said heat generating component to an ambient environment by conduction through said wall portions, and wherein an outer surface of said enclosure comprises fins to facilitate thermal transfer to said ambient environment.

23. A cast enclosure assembly comprising a plurality of cast enclosures as defined in claim 1, wherein one of said cast enclosures encloses a power unit and another one of said cast enclosures encloses a fuel supply for said power unit.
